(19) United States
(12) Patent Application Publication
(10) Pub. No.: US 2006/0272481 A1
(43) Pub. Date: Dec. 7, 2006

(54) Device for electronically transmitting music notes to music stands and method for achieving it

(76) Inventor: Robert Frank, Columbia, SC (US)

Correspondence Address: Robert Frank, 208 Oak Brook Drive, Columbia, SC, 29223-8135, US

(21) Appl. No.: 11/455,828

(22) Filed: Jun. 20, 2006

(51) Int. Cl. G10H 1/00

(52) U.S. Cl. 84/600

(57) ABSTRACT

Display device for music notes and other texts on stands, comprising an image displaying screen, a related image transmitting device and control means for at least successively forwarding text images from said image transmitting device to said image displaying screen. Within the spirit of this invention falls likewise a music stand which includes at least said image displaying screen as well as a method for producing and transferring lines of music notes at a determined speed to said image displaying screen.

### CROSS REFERENCE TO RELATED APPLICATIONS

Not applicable.

### FEDERALLY SPONSERED RESEARCH

not applicable.

### SEQUENCE LISTING OR PROGRAM

Not Applicable.

### BACKGROUND OF THE INVENTION

1. Field of the Invention

This invention relates to a device for electronically showing successive pages of music notes and the like. At least the image display means of the device is adapted to be supported by a music stand, so that a performer can execute the piece of music on his instrument without having to turn printed pages by hand, as he progresses in playing. The same invention may also be used for displaying any other type of successive images. The invention furthermore relates to a music stand including at least said image display means as well as to a method for producing and transferring lines of music notes at a determined speed to said image display means.

2. Background of the Invention

For hundred of years music stands are all of the type to hold paper booklets or sheets of printed or hand written music notes. If the music piece is long enough, several pages are required to show the entire piece. This is even truer for conductors of orchestras, because these music texts have to show the several texts of the instruments forming the orchestra for a symphony or the like piece of music. Thus, the full attention for executing the piece is intermittently reduced, when the player or conductor (both herein after called “performer”), has to turn the page. Even if an assistant performs this, such as done by piano players, the attention of the performer is diminished at this time. The only way to avoid this “loss of concentration” up to now, is that the performer learns the theme by heart and many performers are not capable of doing this for their entire repertoire.

The problem herein above outlined has already been recognized in the past and efforts have been made to solve it. This was always done by providing some kind of structure which enables to put several music sheets one, next to the other on an extendable desk portion of the music stand. This solved the problem as long as for playing the music piece not more then two or three sheets of music had to be displayed. However for truly long pieces of music, no suggestion in this direction has been seen so far.

Typical examples of what is known in the art are shown in:

U.S. Pat. No. 6,802,485 referring to a “Two piece music stand accessory for large books”,

D 433,581 showing a music stand with two spaced apart support columns to provide in between them a longer desk portion,

U.S. Pat. No. 5,114,111 showing a parallelepiped hinged U-shaped music stand which enables to align the side branches with the base portion of the U-shaped member to increase its length, and finally,

U.S. Pat. No. 5,037,057 which proposes a collapsible music stand having a two part split desk portion, which can be spaced apart by sliding on opertinent rails and thereby again increase the total length of the desk portion.

The present invention tends to avoid or at least substantially reduce the problem of “loss of concentration” of the performer on the other hand and to furthermore provide an arrangement which allows displaying in full the music without having to turn by hand pages, no matter how long the piece is. More specifically, this is a complete different approach of solving the problem by a new combination of known electronic means which enables the performer to read on an electronic screen the text, which progresses thereon either intermittently or continuously, in accordance with the decision of the performer.

As will be understood, the field of this invention does not become limited to execute music, but can likewise be used for other purposes, although the main purpose of this invention is for executing music.

The invention further relates to a method for producing the necessary means for generating a suitable electronic text and transferring said text at a determined speed to an electronic screen.

### BACKGROUND OF INVENTION—OBJECT AND ADVANTAGES

Several objects and advantages of the present invention are:

(a) To provide means for enabling to read texts which are longer than one page, without having to turn the pages by hand or by using an assistant.

(b) To provide a flat electronic screen that can be placed on a music stand or the like or such music stand may at least integrate said flat electronic screen of the device of the present invention.

(c) To provide remote control means for advancing the text shown on the screen. The control means may for instance be operated by the foot of the performer. The text may be advanced continuously at a speed which is compatible with the speed the performer advances in his performance or it may be advanced intermittently to become the equivalent to the old system of turning pages.

(d) In case the invention is used for an orchestra, the screens of all the players in the orchestra may be simultaneously controlled by the conductor, as he advances in the executions of the piece. In case of chamber music, where there is no specific conductor (one who does not play an instrument), such control may be provided by one of the players for all of the music notes-display devices.

(e) The text of the existing printed pages to be used by the present invention, may be first filmed by a video-camera. Either successive pages may be filmed or successive lines of the entire text may be filmed and then edited and burned onto a DVD disk by means of a computer. The DVD disk is then to be used by the present invention.

Further objects and advantages will become apparent from a consideration of the ensuing description and drawings.

### SUMMARY

In accordance with the present invention, the display device for music notes and other texts comprises an image displaying screen housable on the desk portion of a music stand. The displaying screen is related to an image transmitting device and control means for at least successively forwarding text images from said image transmitting device to said image displaying screen. Within the spirit of this invention falls likewise a music stand which includes at least said image displaying screen, as well as it refers to a method for performing the invention.

### DRAWINGS—FIGURES

FIG. 1 schematically shows a well known music stand to which the invention may be applied.

FIG. 2 schematically shows an electronic screen, housable onto the desk portion of the stand shown in FIG. 1 or on a stand of the type used on pianos and the like.

FIG. 3 schematically shows an image transmitting device to be connected to the screen.

FIG. 4 schematically shows a foot operable control means.

FIG. 5 schematically shows how the invention can be used for an orchestra, whereby the conductor controls all the electronic screens.

FIG. 6 schematically shows a video-camera.

FIG. 7 schematically shows one page of a music text.

FIG. 8 schematically shows a computer.

FIG. 9 shows a DVD disk.

### DRAWINGS—Reference Numerals

1 known music stand
2 and 102 desk portion
3 support column
4 base portion
5 flat electronic screen
5A front face
5B rear face
6 cable member
7 frame
8 and 108 image transmitting device
9 cable member
10 casing
11 slot
12 lever
13 slot
14 and 114 remote control means
15 foot operated pedal member
16 video camera
17 music text
18, 18A, 18B lines of music notes
19 computer
20 DVD disk

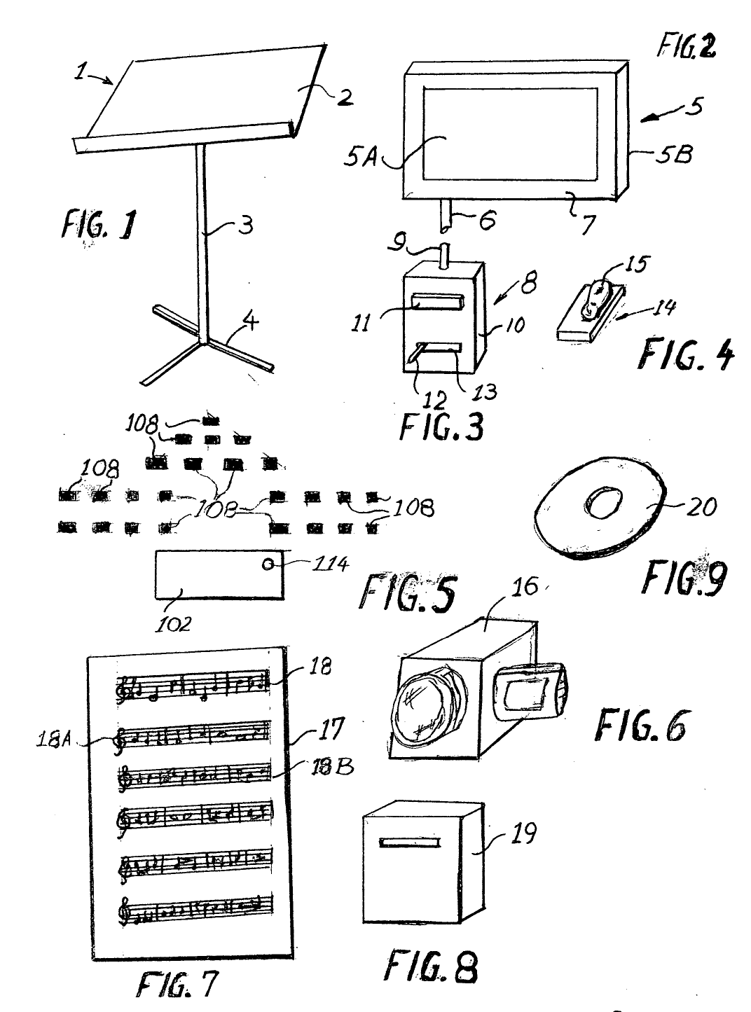

### DETAILED DESCRIPTION—FIGS. 1 to 4—PREFERRED EMBODIMENT

Since the essence of the invention resides in the new combination of known means which enable to achieve a better result for performers, it is not considered necessary to enter into a particular explanation of the circuits of each of the integrating means, to fully understand the present invention, because many different circuits of the required types are well known in the art.

FIG. 1 shows a schematically perspective view of a known music stand 1, of the type used in orchestras, comprising a desk portion 2 supported by the upper end of a support column 3, the lower end of which is provided with a base portion 4, which enables to support the desk portion 2 at a convenient height for the player to read the music to be played.

In case of a conductor's desk or a piano, the desk portion will be supported by pertinent different known means, instead of the support column 3.

FIG. 2 schematically shows a flat electronic screen 5, having an image reproducing front face 5A and a rear face 5B. This enables to place said screen 5 on said desk portion 2, by resting its rear face 5B onto said desk portion 2, whereby the player, conductor or reader can easily and comfortably read the image(s) projected onto said front face 5A of said screen 5. By way of example a cable member 6, projecting out of frame 7, enables to connect said screen 5 to an image transmitting device 8 (see FIG. 3).

The image transmitting device 8 has for instance a cable member 9 to be connected to cable member 6. In the embodiment shown of the image transmitting device 8, the casing 10 has a slot 11 for removable inserting a DVD disc 20 (see FIG. 9), which has registered the music to be played, as previously mentioned, when referring to “Object and Advantages” and will be dealt with in more details, when referring to the “Method of the Invention”. In the embodiment shown, casing 10 is furthermore provided with a speed controlling lever 12 projecting out of slot 13, whereby the transfer of successive images of said DVD disc to said electronic screen 5, may be adjusted to different speeds, if the transmission of the successive images should be continuous. The same lever 12 may however be in a position (say for instance at one end of said slot 13), whereby the image transmitting device is capable of receiving signals from remote control means 14, such as a foot operated pedal member 15, as schematically shown in FIG. 4. Each time the player will press the pedal member 15, the image transmitting device 8 will advance the equivalent of one page of music onto the front face 5A of the flat electronic screen 5 and remove the previous one.

Alternatively, as will be readily understood by anyone skilled in the art, the image transmitting device 8 may be integrated in the flat electronic screen 5 or in the music stand 1.

Operation—FIGS. 1 to 4:

After inserting the text—for instance by means of the previously mentioned DVD disc 20 into said image transmitting device 8, the first portion or “page” will become readable on said front face 5A of the screen 5. If said lever 12 is in the non-operative position, said first text will remain on said front face 5A until the player has reached the end thereof, where upon he will press the pedal member 15, whereby the second text or page will appear on said front face 5A of said screen 5, while the first page will disappear, and so on.

Alternatively, the player may adjust the advancing speed by moving lever 12 into a pertinent position so that successive lines of music will appear and move along said front face 5A at a given speed compatible with his play.

FIGS. 6 to 9—Method of the Invention:

The method of the present invention consists in producing and transferring lines of music notes 18 at a determined speed to an electronic displaying screen 5, comprising the steps of filming for instance with a video-camera 16 (FIG. 6) from an existing music text 17 (FIG. 7) its lines of music 18, 18A, 18B, etc., in a successive manner, one line after the other, transferring the filmed text to a computer 19 (only schematically shown in FIG. 8) and burning said text onto a DVD disc 20 (FIG. 9) to be inserted therefore into said computer 19. Once the DVD disc 20 has received the music text, it can be inserted into said slot 11 of said image transmitting device 8, as previously described to thereby enable the performer to successively read each line of music and play it as well as to advance said lines 18, 18A, 18B, etc. on the screen 5. This can be done in two ways either by positioning the lever 12 in its inoperative position and using the pedal 15 to advance the music text or by positioning lever 12 into one of its operating positions, thereby automatically advancing the lines of music 18 at a convenient speed on the front face 5A of screen 5.

FIG. 5—Additional Embodiment:

A further conceivable alternative is in case the invention is used for an orchestra, as schematically shown in FIG. 5. Similar reference numerals are used as in the previous Figures, but preceded by the numeral “one hundred”. The conductor's desk is identified by reference numeral 102. On his desk a remote control means 114 is mounted, which could be a button operated device, since the conductor can operate it by hand. Control means 114 can emit signals to be simultaneously captured by each of the image transmitting devices 108 of the respective players forming the orchestra. By proceeding along this line it is believed that the conductor exerts a better control on his musicians because the speed of the performance of the entire orchestra depends more on the conductor.

Finally the image transmitting device could of course likewise receive other texts, instead of music notes.

Thus the scope of the invention should be determined by the appended claims and their legal equivalents, rather than by the examples given.

I claim:

1. Display device for music notes and the like for music stands, comprising an image displaying screen, a related image transmitting device and control means for at least successively forwarding text images from said image transmitting device to said image displaying screen.

2. The device of claim 1, wherein said control means include speed control means for transmitting said images in a speed controlled continuous manner to said screen.

3. The device of claim 1, wherein said control means include speed control means for transmitting said images in a speed controlled intermittent manner to said screen.

4. The device of claim 1, wherein said image displaying screen is a flat, electronic image displaying screen having an image reproducing front face and a rear face, said stand having a desk portion, said screen being housable by its rear face on said desk portion.

5. Music stand for reading music pieces having the length of at least two sheets of written music, said sheets to be successively readable without having to turn by hand each sheet, comprising a desk portion including a substantially flat electronic screen having a visible front face, the surface of which is substantially equivalent to the size of any of said sheets, an image transmitting device in image transmitting relationship with said front face for independently transmitting each of said sheets to said front face and remote control means for independently sending at will each sheet of music to said front face.

6. The music stand of claim 5, wherein said control means is connectable to a plurality of image transmitting devices, each forming part of one of said music stands, thereby simultaneously controlling all of said image transmitting devices.

7. Method for producing and transferring lines of music notes at a determined speed to an electronic image displaying screen, comprising the steps of filming from an existing music text having lines of music notes, said lines in a successive manner, transferring the filmed text to a computer, burning said text onto a DVD disc, inserting said disc into an image transmitting device having control means for adjusting the speed with which said music lines are transferable to an image displaying screen and operating said control means at will.
